(19) United States
(12) Patent Application Publication
(10) Pub. No.: US 2018/0111617 A1
(43) Pub. Date: Apr. 26, 2018

(54) CONTROL SYSTEM AND METHOD FOR ALLOWING ANOTHER MOTOR VEHICLE TO PULL IN FRONT FROM A NEIGHBORING LANE DURING ACC OPERATION OF ONE'S OWN MOTOR VEHICLE

(71) Applicant: Lucas Automotive GmbH, Koblenz (DE)

(72) Inventor: Andreas Stahl, Damscheid (DE)

(21) Appl. No.: 15/564,746

(22) PCT Filed: Mar. 31, 2016
(86) PCT No.: PCT/EP2016/057054

§ 371 Date: Oct. 6, 2017

(30) Foreign Application Priority Data
Apr. 7, 2015 (DE) 10 2015 004 478.8

(51) Int. Cl. B60W 30/16; B60W 40/04

(52) U.S. Cl. CPC B60W 30/16; B60W 40/04; B60W 2550/302; B60W 2550/306; B60W 2550/10

(57) ABSTRACT

The invention relates to a control method for establishing in a motor vehicle, on the basis of environment data obtained by one or more environment sensors present on the motor vehicle, that, white an ACC system is active in one's own motor vehicle, another motor vehicle, which is moving relative to one's own motor vehicle in a neighboring lane, has a tendency to change to the lane of one's own motor vehicle. The environment sensor are designed to provide environment data representing the area laterally ahead of, laterally next to and/or laterally behind one's own vehicle. As soon as the environment data representing said tendency exceed a predefined significance threshold, autonomous driving operation interventions (i) are trigged to increase the distance to another motor vehicle which is moving relative to one's own motor vehicle in the same lane ahead of one's own motor vehicle, and/or (ii) the driving speed of one's own motor vehicle is reduced if no other motor vehicle moving relative to one's own motor vehicle in the same lane ahead of one's own motor vehicle is detected to allow another motor vehicle that is moving relative to one's own motor vehicle in the neighboring lane to change lane from the neighboring lane to the lane of one's own motor vehicle.

### RELATED APPLICATIONS

This application corresponds to PCT/EP2016/057054, filed Mar. 31, 2016, which claims the benefit of German Application No. 10 2015 004 478.8, filed Apr. 7, 2015, the subject matter of which are incorporated herein by reference in their entirety.

### BACKGROUND OF THE INVENTION

A control system and a method for allowing another motor vehicle to merge from an adjacent lane during ACC operation of the host motor vehicle are disclosed. This system and method are possible in particular due to the presence of autonomous/adaptive cruise control (ACC) in motor vehicles. The aim is to allow merging with a safe lane change from one lane, for example the passing lane, into the “slower” lane (i.e., in continental Europe or the United States, for example, from the right lane into the left lane), or from the “slower” lane into the passing lane, using the control system and method disclosed herein.

### PRIOR ART

An ACC device, which takes over monitoring the distance from the preceding motor vehicle for the driver and adapts the speed of the host motor vehicle to the speed of a preceding motor vehicle, is described in EP-A-0 612 641, for example. The issue of allowing another motor vehicle to merge from an adjacent lane during ACC operation of the host motor vehicle is not addressed therein.

German Unexamined Patent application DE 10 2007 029 483 A1 discloses a distance control device for motor vehicles, which allows recognition of motor vehicles merging from adjacent lanes. For this purpose, the distance control device includes a sensor that is positioned in the front area of the motor vehicle. The sensor is configured for detecting preceding motor vehicles that are traveling in the same lane as the motor vehicle and also traveling in the adjacent lanes.

German Unexamined Patent application DE 10 2009 007 885 A1 discloses a method for recognizing vehicles that are merging into the host lane or departing the host lane. Surroundings data are obtained by means of a sensor system, not described in greater detail, on the basis of which the likelihood of a lane change by a preceding vehicle to the host lane or an adjacent lane is determined and output.

### UNDERLYING PROBLEM

The ACC device of the host motor vehicle is intended to allow during ACC operation, also for slow-moving traffic traveling in the same direction on multilane roadways, merging of another motor vehicle that is moving relative to the host motor vehicle into an adjacent lane, in a manner that is safe and, for the driver of the host motor vehicle, stress-free.

### PROPOSED SOLUTION

An ACC device is based, among other things, on a surroundings sensor system of the host vehicle (radar, LIDAR, camera, ultrasonic, etc.). The surroundings sensor system is able to detect objects in the surroundings of the host motor vehicle over time. The ACC device may also carry out autonomous driving operation interventions in the host motor vehicle which approximate or correspond to actuations of the braking unit or the accelerator pedal of the host motor vehicle by the driver. These autonomous driving operation interventions include autonomous deceleration as well as autonomous acceleration in order to keep an instantaneous distance between the host motor vehicle and a preceding other motor vehicle essentially constant This distance depends on the speed of the host motor vehicle. The ACC device of the host motor vehicle sets this distance to a safety margin that depends on the speed of the host motor vehicle.

A control system that is configured and intended for use in a motor vehicle determines, based on surroundings data obtained from one or more surroundings sensor(s) situated on the motor vehicle, while the ACC device may be active in the host motor vehicle, that another motor vehicle that is moving relative to the host motor vehicle in an adjacent lane has a tendency to change to the lane of the host motor vehicle. For this purpose, the surroundings sensors are configured for providing to an electronic control system of the control system the surroundings data that reflect the area laterally in front of, laterally to the side of, and/or laterally behind the vehicle, and that are characteristic of this tendency to change lanes.

The control system is at least configured and intended, as soon as the surroundings data reflecting this tendency have exceeded a predetermined significance threshold, by autonomous driving operation interventions to (i) increase the distance from an additional other motor vehicle that is moving relative to the host motor vehicle in the same fane ahead of the host motor vehicle, and/or (ii) reduce the driving speed of the host motor vehicle if the surroundings sensors detect no additional other motor vehicle that is moving relative to the host motor vehicle in the same lane ahead of the host motor vehicle, in order to give the other motor vehicle that is moving relative to the host motor vehicle in an adjacent lane the opportunity to change lanes from the adjacent lane to the lane of the host motor vehicle. The control system may also at least be configured and intended for the ACC device, subsequent to the lane change, to use the other motor vehicle, which is now moving relative to the host motor vehicle in the same lane ahead of the host motor vehicle, as a new control object for the ACC operation of the host motor vehicle.

Since in the prior art such traffic situations are not recognized by conventional ACC devices, they also cannot be handled by the conventional ACC devices in a manner that ensures (traffic) safety and is comfortable for the driver of the host vehicle and also for the driver of the other motor vehicle. When previous ACC devices are in operation, such situations require an intervention by the driver (for example, by deactivating the ACC device and/or driver actuation of the brakes).

### FURTHER EMBODIMENTS AND ADVANTAGEOUS REFINEMENTS

The control system may be configured and intended for detecting and evaluating additional surroundings data from the area laterally to the side of and/or laterally behind the host motor vehicle. This allows a vehicle with a tendency to merge from the other lane into the host lane to be recognized early, and for the necessary steps to be initiated. In particular, a tendency of a vehicle from the other lane to merge into the host lane may be considered by detecting and evaluating any transverse movements of the other vehicle from the other lane, or also the status of the travel direction change indicator (blinker) of the other vehicle.

In one variant, transverse movements of the other vehicle are acquired in the control system by image processing of video data from one or more cameras on the host motor vehicle.

In another variant, the host motor vehicle has at least one radar sensor, laterally in front in the corner area of the host vehicle, having a monitoring area. This radar sensor supplies to the electronic control system, which receives signals, acquires the surroundings data, processes these signals and data, and generates control signals and/or output signals.

Within the scope of data fusion carried out in the electronic control system, the information acquired by image processing of video data from one or more cameras, as well as the information detected by means of the at least one radar sensor, may be processed in the electronic control system in order to recognize in a reliable and timely manner the tendency to merge from the other lane into the host lane.

Furthermore, situations may arise in which there is no active merging of another vehicle ahead of the host vehicle. This is the case, for example, when another vehicle approaches from behind on national highways or expressways, in which the incoming acceleration lane merges into a new lane. Such a situation cannot be recognized in every case by the one or more surroundings sensor(s) of the host motor vehicle for the further monitoring area in front of the vehicle.

### BRIEF DESCRIPTION OF THE DRAWINGS

Further aims, features, advantages, and possible applications result from the following description of exemplary embodiments, which are not to be construed as limiting, with reference to the associated drawings. All features described and/or graphically illustrated, alone or in any combination, constitute the subject matter disclosed herein, also independently of their grouping in the claims or their back-references. The dimensions and proportions of the components shown in the figures are not necessarily to scale, and in the embodiments to be implemented may differ from those illustrated herein.

FIG. 1 schematically shows a first driving situation in which a host motor vehicle is driving in a left lane, with ACC in operation, behind another motor vehicle at a distance that is dependent on the host motor vehicle speed, while a different motor vehicle with its travel direction change indicators signals the intention to merge from the right lane into the left lane.

FIG. 2 schematically shows a second driving situation in which the host motor vehicle in its left lane has detected the merging tendency of the other motor vehicle, and has increased the distance from the preceding additional other motor vehicle, so that the other motor vehicle may recognize the opportunity to merge ahead of the host motor vehicle from the right lane into the left lane.

FIG. 3 schematically shows a third driving situation in which, after merging of the other motor vehicle is completed, the ACC device of the host motor vehicle in the left lane adjusts the distance of the host motor vehicle from the merged other motor vehicle to a safety margin, as a function of the speed of the host motor vehicle.

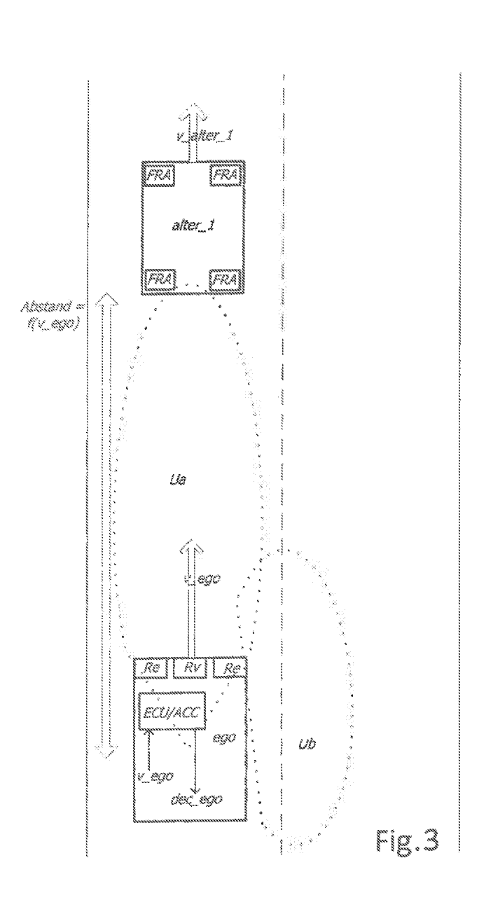

### DETAILED DESCRIPTION OF THE DRAWINGS

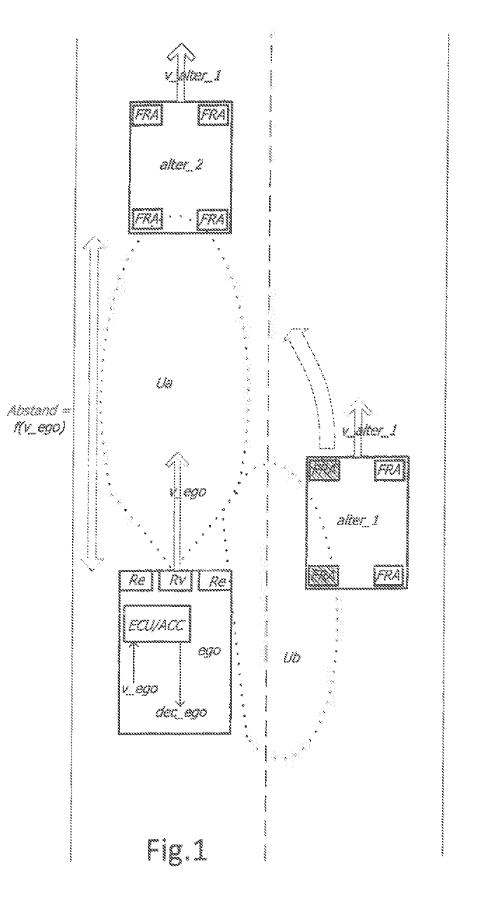

The driving situation schematically shown in FIG. 1 is typical for slow-moving traffic. The motor vehicles are moving in the lanes at similar speeds. A host motor vehicle ego is traveling here in a left lane at a host vehicle speed v_go, white another vehicle alter_1 is traveling in the right lane at a speed v_alter_1 that is the same or approximately the same, but slightly higher.

The host motor vehicle ego has an electronic control system ECU that receives signals, acquires the surroundings data, processes these signals and surroundings data, and generates control signals and/or output signals. A radar sensor Re, not explained in greater detail, situated laterally in front in the corner area of the host vehicle ego has a first monitoring area Ua. A front radar sensor Rv situated in the middle area of the host vehicle ego has a second monitoring area Ub. The radar sensors Rv and Re supply the electronic control system ECU with radar signals concerning the distance, the speed difference between the host vehicle ego and the other vehicle alter_1, and the travel direction and/or the angle of rotation of the other motor vehicle alter_1 about its vertical axis.

In addition to the two radar sensors, the control system described here, which is configured and intended for use in a motor vehicle, may optionally have even further surroundings sensors (video, ultrasonic, LIDAR, etc.) for detecting the surroundings of the host vehicle ego. The electronic control system ECU processes the surroundings data, obtained from the surroundings sensor(s) (radar sensors Rv, Re) situated on the motor vehicle, in order to determine whether another motor vehicle alter_1, which is moving relative to the host motor vehicle ego in an adjacent lane to the left or the right, approximately at the same speed or slightly faster, has a tendency to change to the lane of the host motor vehicle ego. For this purpose, the surroundings sensors Rv, Re of the electronic control system ECU provide surroundings data that reflect the area laterally in front of, laterally to the side of, and/or laterally behind the vehicle.

The surroundings sensors continuously detect one or more other vehicles using the road laterally in front of, laterally to the side of, and/or laterally behind the host motor vehicle ego in order to determine parameters concerning the driving situation(s) of the other vehicle(s). These parameters include, for example, the speed, location as a function of time, and travel direction of the other vehicle(s).

This electronic control system ECU of the control system may at least be configured and intended for determining, during a predetermined time period which includes the passing operation, for example, or continuously in the electronic control system ECU, the driving data of the host motor vehicle ego that reflect the driving situation from signal generators present in the host motor vehicle ego. These signal generators may include, for example, the tachometer or the electronic control system of the braking system (ABS, ESP) which delivers a signal that reflects the speed of the host motor vehicle ego to the electronic control system ECU.

The electronic control system ECU determines, based on the driving data that reflect the driving situation of the host vehicle ego and the parameters concerning the tendency of one or more other vehicles using the road, located laterally in front of, laterally to the side of, and/or laterally behind the host motor vehicle ego, whether one or more of these other vehicles has/have a tendency to change to the lane of the host motor vehicle ego. When the control system determines that the surroundings data reflecting this tendency have exceeded a predetermined significance threshold, the control system triggers autonomous driving operation interventions in order to increase the distance from an additional other motor vehicle alter_2 that is moving relative to the host motor vehicle ego in the same lane ahead of the host motor vehicle ego. Alternatively, the control system causes the driving speed of the host motor vehicle ego to be reduced if the surroundings sensors detect no additional other motor vehicle alter_2 that is moving relative to the host motor vehicle ego in the same lane ahead of the host motor vehicle ego. As a result of this measure, the other motor vehicle after_1 that is moving relative to the host motor vehicle ego in the adjacent lane is given the opportunity to change lanes from the adjacent lane to the lane of the host motor vehicle ego.

Subsequent to the lane change, the ACC device in the host motor vehicle ego uses the other motor vehicle alter_1, which is now moving relative to the host motor vehicle ego in the same lane ahead of the host motor vehicle ego, as the new control object for the ACC operation of the host motor vehicle ego.

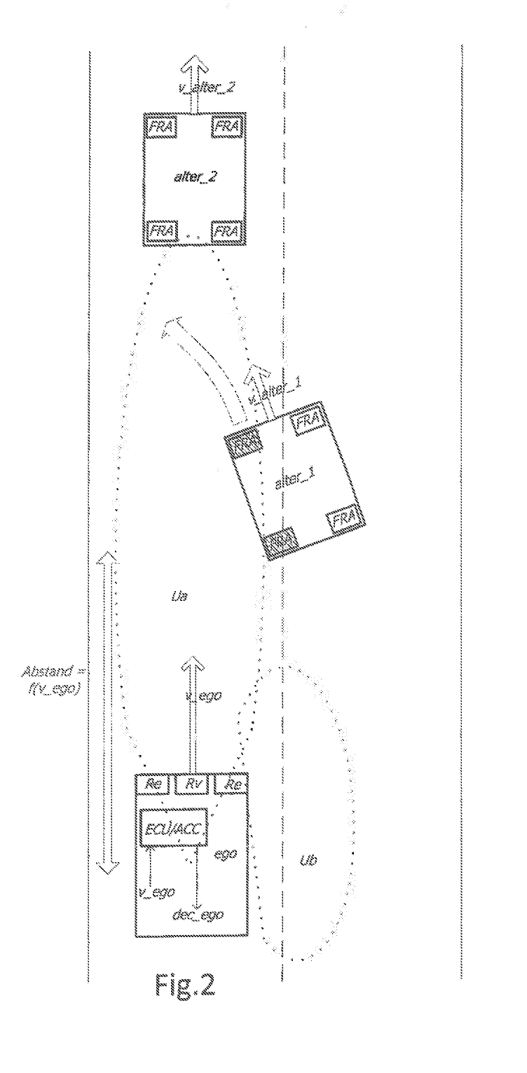

As illustrated in FIG. 2, the radar, video, ultrasonic, and/or LIDAR sensors, as surroundings sensors for the area laterally in front of, laterally to the side of, and/or laterally behind the host vehicle ego, are also configured for detecting any transverse movements of the other vehicle in the direction from the other lane into the host vehicle lane, and/or detecting the status of at least one travel direction change indicator of the other vehicle. These data are to be used in recognizing this merging tendency of the other motor vehicle alter_1. The surroundings data from these sensors are evaluated in the control system with regard to whether there is a merging tendency, and if so, to what extent. If the data have too little significance, in another variant, in addition to these surroundings data the transverse movements of the other vehicle or activities of at least one travel direction change indicator of the other vehicle are determined by image processing of video data from one or more cameras on the host motor vehicle ego. Moreover, in another variant the electronic control system ECU determines the transverse movements of the other vehicle by signal analysis of radar data from one or more radar sensors on the host motor vehicle ego.

The presence of a tendency of the other motor vehicle to merge from the adjacent lane into the host lane is queried in a further condition. This condition is the traffic flow in the adjacent, slower lane, for example the right lane. For example, if a slower-moving vehicle is recognized ahead of the motor vehicle that is traveling in the host lane and is moving with the traffic flow, this condition may additionally be used.

If a similar movement of the other motor vehicle after_1 with respect to the host motor vehicle in the left, faster lane, and in addition the intention to make a lane change, are recognized, this is determined by the control system. The control system then triggers autonomous driving operation interventions in order to increase the distance from an additional other motor vehicle alter_2 that is moving relative to the host motor vehicle ego in the same lane ahead of the host motor vehicle ego. Alternatively, the control system causes the driving speed of the host motor vehicle ego to be reduced if the surroundings sensors detect no additional other motor vehicle alter_2 that is moving relative to the host motor vehicle ego in the same lane ahead of the host motor vehicle ego.

Merging of the other motor vehicle alter₁₃1 into the faster left lane ahead of the host motor vehicle ego is thus made possible. Another motor vehicle alter_1 subsequently becomes the new control object for the ACC controller of the host motor vehicle ego.

In another variant not illustrated in the drawings, the host motor vehicle ego is in ACC operation without a control object. In this case, the control distance from the preceding vehicle is not increased, and instead the instantaneous control speed is reduced.

The variants described above as well as their design and operational aspects are used solely for better understanding of the structure, the operating principle, and the properties; they do not limit the disclosure to the exemplary embodiments, for example. The figures are sometimes schematic, and important properties and effects are sometimes illustrated in much larger scale, in order to clarify the functions, functional principles, technical embodiments, and features. Any operating principle, any principle, any technical embodiment, and any feature that is disclosed in the figures or in the text, together with all claims, may be freely and arbitrarily combined with any feature in the text and with the other figures, other operating principles, principles, technical embodiments, and features that are contained in the present disclosure or result therefrom, so that all conceivable combinations of the described variants are to be assigned. Also encompassed are combinations between all individual statements in the text, i.e., in any section of the description, in the claims, as well as combinations between various variants in the text, in the claims, and in the figures. Furthermore, the claims do not limit the disclosure, or thus, the combination options of all disclosed features with one another. All disclosed features are also explicitly disclosed herein, individually and in combination with all other features.

1-14. (canceled)

15. A control system that is configured and intended for use in a motor vehicle, including a surroundings sensor (Re) laterally in front in the corner area of the motor vehicle, having a monitoring area (Ua), and a surroundings sensor (Rv) situated in front in the middle area of the motor vehicle, having a monitoring area (Ub), wherein the surroundings sensors (Rv, Re) are configured for continuously detecting the area laterally in front of, laterally to the side of, and laterally behind the host motor vehicle (ego) in order to determine the speed, location as a function of time, and the travel direction of another vehicle (alter_1), detecting a transverse movement of the other vehicle in the direction from the other lane into the host lane, and detecting the status of a travel direction change indicator of the other vehicle, wherein the control system is configured for determining, while an ACC device is active in the host motor vehicle, that the other motor vehicle (alter_1) that is moving relative to the host motor vehicle (ego) in an adjacent lane has a tendency to change to the lane of the host motor vehicle (ego), wherein the surroundings sensors (Rv, Re) are configured for continuously providing to an electronic control system (ECU) of the control system the surroundings data that reflect the area laterally in front of, laterally to the side of, and laterally behind the host motor vehicle (ego), and the control system is at least configured and intended, as soon as the surroundings data reflecting this tendency have exceeded a predetermined significance threshold, by autonomous driving operation interventions to (i) increase the distance from an additional other motor vehicle (alter_2) that is moving relative to the host motor vehicle (ego) in the same lane ahead of the host motor vehicle (ego), and/or (ii) reduce the driving speed of the host motor vehicle (ego) if the surroundings sensors detect no additional other motor vehicle (alter_2) that is moving relative to the host motor vehicle (ego) in the same lane ahead of the host motor vehicle (ego), in order to give the other motor vehicle (alter_1) that is moving relative to the host motor vehicle (ego) in the adjacent lane the opportunity to make a lane change from the adjacent lane to the lane of the host motor vehicle (ego).

16. The control system according to claim 15, which is configured and intended for the ACC device, subsequent to the lane change, to use the other motor vehicle (alter_1), which is now moving relative to the host motor vehicle (ego) in the same lane ahead of the host motor vehicle (ego), as a new control object for the ACC operation of the host motor vehicle (ego).

17. The control system according to claim 15, which is configured and intended for giving the other motor vehicle (alter_1) the opportunity to make a lane change from the adjacent lane to the lane of the host motor vehicle (ego) if the motor vehicle in the host lane and also the motor vehicle in the adjacent lane are traveling at similar speeds.

18. The control system according to claim 15, wherein radar, video, ultrasonic, and/or LIDAR sensors are provided as surroundings sensors for detecting the surroundings data in order to provide the electronic control system (ECU) with surroundings data that reflect the area laterally in front of, laterally to the side of, and/or laterally behind the host vehicle (ego).

19. A control method that is based on surroundings data obtained with a surroundings sensor (Re) laterally in front in the corner area of the motor vehicle, having a monitoring area (Ua), and a surroundings sensor (Rv) situated in front in the middle area of the motor vehicle, having a monitoring area (Ub), wherein the surroundings sensors (Rv, Re) continuously detect the area laterally in front of, laterally to the side of, and laterally behind the host motor vehicle (ego) in order to determine the speed, location as a function of time, and the travel direction of another vehicle, detecting a transverse movement of the other vehicle in the direction from the other lane into the lane of the host motor vehicle, and detecting the status of a travel direction change indicator of the other vehicle, wherein the control system determines, using the surroundings data obtained from the surroundings sensors (Rv, Re), while an ACC device is active in the host motor vehicle, that the other motor vehicle (alter_1) that is moving relative to the host motor vehicle (ego) in an adjacent lane has a tendency to change to the lane of the host motor vehicle (ego), wherein the surroundings sensors (Rv, Re) are configured for continuously providing surroundings data that reflect the area laterally in front of, laterally to the side of, and laterally behind the host motor vehicle (ego), and as soon as the surroundings data reflecting this tendency have exceeded a predetermined significance threshold, autonomous driving operation interventions are triggered to (i) increase the distance from an additional other motor vehicle (alter_2) that is moving relative to the host motor vehicle (ego) in the same lane ahead of the host motor vehicle (ego), and/or (ii) reduce the driving speed of the host motor vehicle (ego) if the surroundings sensors detect no additional other motor vehicle (alter_2) that is moving relative to the host motor vehicle (ego) in the same lane ahead of the host motor vehicle (ego), in order to give the other motor vehicle (alter_1) that is moving relative to the host motor vehicle (ego) in the adjacent lane the opportunity to make a lane change from the adjacent lane to the lane of the host motor vehicle (ego).

20. The control method according to claim 19, wherein subsequent to the lane change, the ACC device uses the other motor vehicle (alter_1), which is now moving relative to the host motor vehicle (ego) in the same lane ahead of the host motor vehicle (ego), as a new control object for the ACC operation of the host motor vehicle (ego).

21. The control method according to claim 19, wherein another motor vehicle (alter_1) is given the opportunity to make a lane change from the adjacent lane to the lane of the host motor vehicle (ego) if the motor vehicle in the host lane and also the motor vehicle in the adjacent lane are traveling at similar speeds.

22. The control method according to claim 19, wherein radar, video, ultrasonic, and/or LIDAR sensors are provided as surroundings sensors for detecting the surroundings data in order to provide the electronic control system (ECU) with surroundings data that reflect the area laterally in front of, laterally to the side of, and/or laterally behind the host vehicle (ego).
